(19) United States
(12) Patent Application Publication
(10) Pub. No.: US 2026/0126007 A1
(43) Pub. Date: May 7, 2026

(54) GAS TURBINE ENGINE FOR AN AIRCRAFT

(71) Applicant: Rolls-Royce Deutschland Ltd & Co KG, Blankenfelde-Mahlow (DE)

(72) Inventors: Gideon Daniel VENTER, Berlin (DE); Michael SCHACHT, Berlin (DE)

(21) Appl. No.: 19/304,011

(22) Filed: Aug. 19, 2025

(30) Foreign Application Priority Data
Aug. 30, 2024 (DE) 10 2024 124 928.5

(51) Int. Cl. F02C 7/06; B64D 27/10; B64D 33/08

(52) U.S. Cl. CPC F02C 7/06; B64D 27/10; B64D 33/08; F05D 2260/98

(57) ABSTRACT

Proposed is a gas turbine engine for an aircraft, having an oil system that includes an oil tank and at least one shaft that is mounted rotatably on a casing by means of bearing units. At least one of the bearing units and the oil tank are arranged in a bearing chamber.

This application claims priority to German Patent Application 102024124928.5 filed Aug. 30, 2024, the entirety of which is incorporated by reference herein.

The present disclosure relates to a gas turbine engine for an aircraft of the type defined in greater detail in the preamble of patent claim 1.

The fuel consumption of aircraft is influenced by various factors. The fuel consumption of an aircraft is influenced not only by the flight profile, the total weight of an aircraft, the weather conditions, the flight altitude, the flight route and the engine efficiency but also by the aerodynamics or the design of the aircraft as a whole.

In general, larger aircraft exhibit improved consumption characteristics per passenger than smaller aircraft. To improve the consumption characteristics of larger aircraft in particular, it is increasingly sought to minimize the external dimensions of aircraft gas turbines.

As is known, gas turbine engines are equipped with oil systems in order to be able to supply oil to various regions during operation. A wide variety of measures are implemented in order to avoid a complete loss of oil in the event of damage caused by detached engine parts. In a first group of known aircraft systems, an oil tank of the oil system of a gas turbine engine is arranged within the aircraft. This offers the possibility of designing such a gas turbine engine to be as small as possible. This approach however increases the outlay in terms of construction for the supply of oil to the gas turbine engine, because the oil, in particular for supplying to bearing units of drive shafts of a gas turbine engine, must be conducted from the oil tank arranged in the aircraft into the interior of the gas turbine engine, and the returned oil must subsequently be conducted back into the aircraft to the oil tank.

A second group of gas turbine engines comprises at least one oil tank arranged on the aircraft and a further oil tank arranged in the gas turbine engine in the region of an ancillary-equipment gear box. A loss of oil from the oil system of a gas turbine engine can be compensated for from the oil tank the aircraft by virtue of the oil tank of the gas turbine engine being replenished with oil from the oil tank in the aircraft by remote control by the flight crew.

The arrangement of the oil tank in the gas turbine engine in the region of the ancillary-equipment gear box however makes it difficult to aerodynamically optimize a gas turbine engine.

The present disclosure is based on the object of providing a gas turbine engine for an aircraft having an oil tank of a gas-turbine oil system, in which a supply of oil to various components of the gas turbine engine is achieved with little outlay in terms of construction, and said gas turbine engine is of aerodynamically optimized design.

Said object is achieved according to the invention by means of a gas turbine engine having the features of patent claim 1. Advantageous refinements form the subject matter of the dependent claims and of the following description.

Proposed is a gas turbine engine for aircraft, having an oil system that is configured with an oil tank. At least one shaft of the gas turbine engine is mounted rotatably on a casing by means of bearing units. At least one of the bearing units is arranged in a bearing chamber.

The oil tank is arranged in a hitherto unused installation space within the bearing chamber. This offers the possibility of designing the gas turbine engine to have smaller external dimensions than known gas turbine engines, and to thus be aerodynamically optimized, or of arranging additional components within an installation space, which was previously provided for the oil tank, in the gas turbine engine whilst maintaining the same dimensions. If the arrangement of the oil tank in the bearing chamber is used to improve aerodynamics by reducing the external dimensions of the gas turbine engine, this is conducive to achieving, in a simple manner, a reduction of the fuel consumption of an aircraft equipped with the gas turbine engine according to the present disclosure in relation to aircraft having aircraft engines of aerodynamically less favorable design.

Furthermore, a fire-resistant design of the oil tank can be dispensed with, because the interior of the bearing chamber does not constitute a safety-critical fire zone of the gas turbine engine.

Furthermore, owing to the arrangement of the oil tank in the bearing chamber, a loss of oil from the gas turbine engine even in the event of a leak in the region of the oil tank is reduced or avoided, because oil escaping in uncontrolled fashion from the oil tank can be collected in the bearing chamber and returned via a return line of the bearing chamber into the oil circuit of the oil system.

Furthermore, the likelihood of damage caused by detached engine parts and by projectiles is, with little outlay, reduced in relation to an arrangement of the oil tank outside an engine core and thus outside the bearing chamber, in particular in the region of an ancillary-equipment gear box, which has a positive effect on the operation approval process for a gas turbine engine.

An interior space of a casing of the oil tank may be connected via a venting line to a breather, in the region of which the amount of oil in the air can be reduced. The loss of oil from the gas turbine engine during operation is thus minimized in a simple manner.

An interior space of the bearing chamber may be connected via a venting line to the breather in order to keep the loss of oil from the gas turbine engine during operation correspondingly low.

It is also possible that an interior space of a casing of the oil tank is connected via a venting line to an interior space of the bearing chamber. Venting of the oil tank into the bearing chamber is then possible in a structurally simple manner, without increasing a loss of oil from the oil system.

In a refinement of the gas turbine engine according to the present disclosure, the interior space of the bearing chamber may be connected to a breather, in the region of which the amount of oil in the air can be reduced.

To avoid an excessive pressure rise in particular in the bearing chamber and in the oil tank, air having an oil load that has been reduced in the breather in relation to the oil load of the air in the oil tank and in relation to the oil load of the air in the bearing chamber may be discharged from the breather via an air line to the surroundings around the gas turbine engine.

A pressure-limiting valve may be arranged in the venting line of the oil tank. Below a defined pressure in the casing of the oil tank, the venting line of the oil tank can be blocked in the direction of the bearing chamber or of the breather by means of the pressure-limiting valve. An undesired pressure drop in the oil tank can thus be avoided in a simple manner, in particular at high flight altitudes. This offers the possibility that a feed pump connected to the oil tank can be charged with a defined minimum pressure level on a suction side. Such a minimum pressure level advantageously lies above a threshold pressure value above which cavitation in the region of the feed pump, which impairs the functioning of the feed pump, does not occur.

If, in the installed position of the oil tank, an oil extraction line opens out into a bottom region of the casing of the oil tank or branches off from a lower region of the casing of the oil tank, virtually the entire oil volume present in the oil tank can be used in the oil system for the purposes of lubricating and cooling, and if appropriate hydraulically actuating, various assemblies of the gas turbine engine. The oil extraction line may be connected to a suction side of a feed pump that is arranged outside the bearing chamber. It is thus possible for an oil volume that is to be provided in the oil tank, and external dimensions correlating therewith and ultimately an installation space requirement of the oil tank, to be reduced in relation to known solutions, in which an unusable oil volume is larger.

Furthermore, an oil separator may be arranged on the casing of the oil tank, in the region of which oil separator oil can be separated off from an air-oil volume flow during the operation of the gas turbine engine. Oil that has been separated off can thus be conducted, in a structurally simple manner that is favorable in terms of installation space, via an oil line from the oil separator into the oil tank, and the pre-purified air can be conducted via an air line from the oil separator in the direction of the breather, in the region of which the amount of oil in the pre-purified air can be further reduced.

Furthermore, an air-oil volume flow may be introduced into the oil separator from the bearing units via a return line of the oil system.

In a further embodiment of the gas turbine engine according to the present disclosure, the oil tank is adapted to the installation space available within the bearing chamber, and at the same time the unusable oil volume stored in the interior of the oil tanker substantially reduced. For this purpose, an upper region of the casing of the oil tank in an installed position may be annular. Furthermore, an adjoining lower region has flattened casing sides which converge on one another in the circumferential direction of the casing of the oil tank and which delimit the volume of the oil tank.

In order, over the entire range of operation of an aircraft equipped with the gas turbine engine according to the present disclosure, to minimize the unusable oil volume that cannot be extracted from the oil tank owing to its structural design, the lower casing region of the oil tank may taper continuously in the axial direction proceeding from the upper casing region in the direction of a lower end of the casing.

In other words, the casing of the oil tank thus not only has substantially a triangular external shape in the lower region of the casing in the circumferential direction, but is also formed, in a side view, with a shape which converges in a triangular shape downwardly in the vertical direction of the oil tank.

The casing of the oil tank may preferably delimit, in the radial direction, a preferably circular aperture through which the shaft extends in the axial direction. In such an embodiment of the gas turbine engine according to the present disclosure, a hitherto unused installation space within the bearing chamber is utilized, in a structurally simple manner that is favorable in terms of installation space, for the arrangement of the oil tank. Furthermore, the oil tank designed in this way can also be integrated with little outlay in terms of construction into existing gas turbine engine systems.

The casing may have a plurality of lines which extend in the axial direction from a first side wall of the casing through the interior space of the oil tank to a second side wall of the casing.

It is possible here for oil to be conducted through the oil tank in the direction of one of the bearing units in the bearing chamber through at least one of the lines, and for sealing air for sealing off the bearing chamber to be conducted through at least one other of the lines.

An impairment of the supply of oil to the bearing unit and of the sealing of the bearing chamber by the oil tank arranged in the bearing chamber is thus prevented with little outlay in terms of construction.

The oil tank may be operatively connectable via a pressure filling valve to a remote filling unit, via which oil can be conducted in automated fashion into the oil tank from a further aircraft oil tank by a feed pump. The oil tank may additionally be operatively connectable to a manual pressure filling unit, from which oil can be introduced into the oil tank manually and under pressure.

An oil line which connects the manual pressure filling unit and the pressure filling valve may extend through a bypass flow strut which extends in a radial direction between, and fixedly interconnects, two annular casing regions. The manual pressure filling unit can then be easily arranged for example in the interior of an engine nacelle and close to an outer side of the engine nacelle, and filling of the oil tank is possible with oil with little installation effort being expended for the purposes of compensating for oil losses.

The pressure filling valve may have a valve piston which, in the unpressurized state, is forced sealingly against a first valve seat by a spring element and shuts off the connections between the remote filling unit and the oil tank and between the manual pressure filling unit and the oil tank. When an opening pressure is applied from the remote filling unit or from the manual pressure filling unit, the valve piston can open up the associated connection, and the oil tank can be filled automatically from the aircraft or manually by an operating person.

In the region of a first connection of the pressure filling valve, said first connection being connected to the remote filling unit, and in the region of a second connection, which is connected to the manual pressure filling unit, there may be in each case one check valve. It is possible here that the check valves open up the associated connection when the pressure in the pressure filling valve is lower than that in the respective filling line between the remote filling unit and the pressure filling valve and between the manual pressure filling unit and the pressure filling valve.

The valve piston, in the unpressurized state, may additionally lie sealingly against a second valve seat and separate a third connection from a fourth connection of the pressure filling valve. Here, the third connection may be connected to the venting line of the oil tank, and a leakage line may branch off from the fourth connection of the pressure filling valve and produce a connection to a drain mast.

In the region of the drain mast, which is preferably arranged close to an outer side of the engine nacelle, lines open out which each produce connections between various regions in the interior of the gas turbine engine and the drain mast and from which leakage oil emerges following the occurrence of undesired events in the gas turbine engine. Such events may for example be sudden oil leaks from engine components or engine regions, or else overfilling of the oil tank. On the basis of leakage oil that emerges from the lines in the region of the drain mast, an operating person can carry out a functional check of the gas turbine engine with little effort by way of a visual inspection.

A fifth connection of the pressure filling valve may be connected via a filling line to the oil extraction line, and, when the first valve seat is open, may be connected to the first connection and to the second connection.

The oil tank can thus be filled either in automated fashion, with little outlay in terms of open-loop and closed-loop control, from the remote filling unit, or manually from the manual pressure filling unit.

The valve seats and the valve piston may be configured such that, when the first valve seat is open, the valve piston also opens up the second valve seat. It is thus achieved that, during a process of filling the oil tank, the interior space of the oil tank is ventilated to the required extent via the pressure filling valve, and an overpressure in the oil tank during the filling process is avoided.

If the valve piston permanently separates the third connection and the fourth connection from the first connection, from the second connection and from the fifth connection, a loss of oil in the direction of the drain mast during a process of filling of the oil tank is avoided in a simple manner.

A filling interface of the manual pressure filling unit may be arranged in the region of an outer side of an engine nacelle and, in an installed position, preferably in a lower region of the engine nacelle. The filling interface of the manual pressure filling unit is then easily accessible to operating persons even in the case of relatively large aircraft.

The filling interface of the manual pressure filling unit may be connectable through an opening in the outer side of the engine nacelle to an oil pressure source. Furthermore, the opening may be sealingly closable by means of a covering flap, and an outer side of the covering flap may terminate flush with the opening of the engine nacelle in an aerodyamically favorable manner in an operating state in which said covering flap closes the aperture.

The manual pressure filling unit may have a visual oil level display or a type of oil inspection glass that indicates the oil level in the oil tank preferably via a glass fiber optical system. An operating person can then easily directly monitor the filling operation and avoid overfilling the oil tank.

When the oil tank is in an installed position and an aircraft equipped with the gas turbine engine is in flight attitudes at which the aircraft assumes a roll angle of +/−40° about a longitudinal axis and a pitch angle of +/−40° about a transverse axis relative to a horizontal flight attitude, an opening of the venting line in the interior of the oil tank may be arranged with a defined offset value above a defined maximum oil level in the oil tank.

An escape of oil from the oil tank is thus easily avoided over the entire range of operation of the gas turbine engine according to the present disclosure, as long as the oil tank contains only an oil volume that does not exceed the maximum oil volume. Oil consumption, or a loss of oil from the oil system, are thus minimized in a simple manner.

The oil tank may be operatively connectable via a T-piece to a manual filling unit, from which oil can be introduced into the oil tank manually and under the action of gravitational force.

In other words, via such a manual filling unit, the oil tank can be filled without additional aids such as an oil pump and the like, simply by virtue of oil being poured from an oil container into the manual filling unit.

If the manual filling unit has an oil filler neck and has a flap valve arranged between a filling opening and an interior space of the manual filling unit, the oil system is closed by the flap valve outside of filling operations even if the filling opening of the manual filling unit has not been closed. An undesired escape of oil via the filling opening is thus prevented in a structurally simple manner.

If the pressure filling valve is connected to a venting line of the manual filling unit, an undesired pressure rise in the interior of the manual filling unit during a process of filling the oil tank is avoided in a simple manner.

It is furthermore possible that the manual filling unit comprises a sensor device which serves for determining the oil level in the oil tank and which is preferably designed as an inductively, capacitively or magnetically measuring sensor device.

This in turn offers the possibility that an automatic process of filling the oil tank from the remote filling unit can be monitored by an operating person from the cockpit of the aircraft without visual monitoring, and overfilling of the oil tank can be avoided.

It is furthermore also possible that the manual filling unit has an inspection device having a transparent element, via which an oil level in the oil tank can be visually directly ascertained. This enables an operating person to monitor the filling operation, for example via an oil inspection glass, and to avoid overfilling of the oil tank.

The invention is not limited to the indicated combinations of features in the independent claims or in the claims dependent thereon. Within the scope of the claims, there are furthermore possibilities of combining individual features, insofar as they are apparent from the claims, the following description of embodiments or directly from the drawing. The reference to the drawings by the claims through the use of reference signs is not intended to limit the scope of protection of the claims.

Preferred refinements of the disclosed subject matter will become apparent from the dependent claims and the following description. Exemplary embodiments of the invention are explained in more detail with reference to the drawing, without being limited thereto.

### In the Figures:

FIG. 1 is a partial view of an intermediate casing of a gas turbine engine and of an oil system of the gas turbine engine;

FIG. 2 is a further view of the intermediate casing and of the system of the gas turbine engine according to FIG. 1;

FIG. 3 is a further view of the oil system and of the intermediate casing, with the intermediate casing illustrated in transparent form;

FIG. 4 is a longitudinal sectional view of a front region of the gas turbine engine according to FIG. 1 and of a sub-region of the oil system;

FIG. 5 is a schematic diagram of the oil system of the gas turbine engine according to FIG. 1;

FIG. 6 is a three-dimensional partial illustration of the oil system of the gas turbine engine according to FIG. 1;

FIG. 7 is an illustration, corresponding to that of FIG. 6, of the oil system in a view VII as indicated more specifically in FIG. 6;

FIG. 8 is a highly simplified stand-alone illustration of the intermediate casing of the gas turbine engine according to FIG. 1 in a view from the rear;

FIG. 9 is a partial view of a front region of the gas turbine engine according to FIG. 1, in which lines extend through an oil tank of the oil system in an axial direction of the gas turbine engine;

FIG. 10a is a sectional view of the oil tank according to FIG. 9 when an aircraft equipped with the gas turbine engine is in a horizontal flight attitude;

FIG. 10b is an illustration, corresponding to FIG. 10a, of the oil tank during climbing flight, in which the aircraft has been tilted upward about a transverse axis;

FIG. 10c is an illustration, corresponding to FIG. 10a, of the oil tank during descending flight, in which a front end of the aircraft has been tilted downward about the transverse axis of the aircraft;

FIG. 11a shows a cross-sectional view of the oil tank during horizontal flight;

FIG. 11b is an illustration, corresponding to FIG. 11a, of the oil tank in a flight condition in which the aircraft has been tilted counterclockwise about a longitudinal axis of the aircraft;

FIG. 11c is an illustration, corresponding to FIG. 11a, of the oil tank in a flight condition in which the aircraft has been tilted clockwise about its longitudinal axis in relation to the horizontal flight attitude;

FIG. 12a is a side view of a manual filling unit by means of which the oil tank can be filled with oil under the action of gravitational force and in the region of which an oil level in the oil tank can be determined by sensor means and can also be visually ascertained by an operating person;

FIG. 12b is a sectional view of the manual filling unit according to FIG. 12a;

FIG. 13 is an enlarged view of a region XIII of the oil system, indicated more specifically in FIG. 6, in which a pressure filling valve is arranged;

FIG. 14 is a sectional view of the pressure filling valve according to FIG. 13;

FIG. 15 is an enlarged view of a region XV indicated more specifically in FIG. 4, in which a so-called drain mast and a manual pressure filling unit are arranged;

FIG. 16 is a three-dimensional stand-alone illustration of the drain mast and of the manual pressure filling unit in a view obliquely from below; and

FIG. 17 shows the region XV in a view XVII indicated more specifically in FIG. 15.

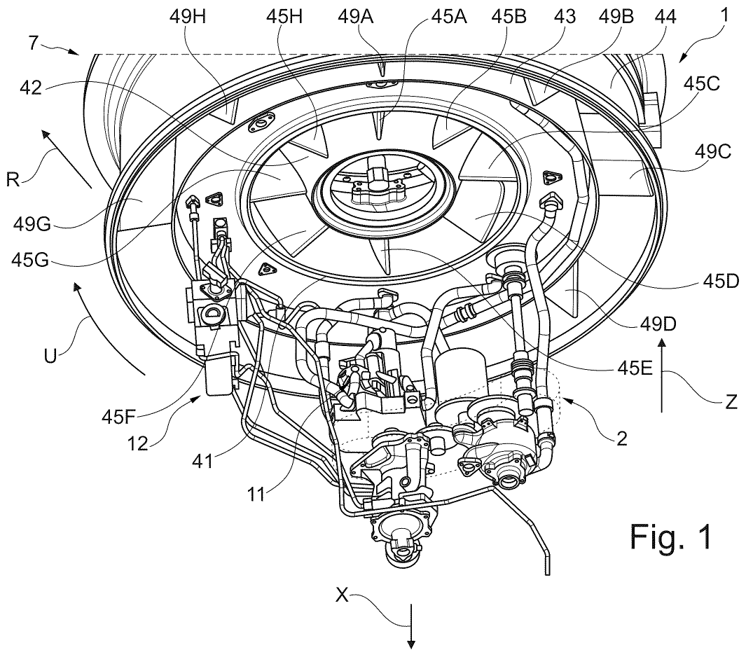

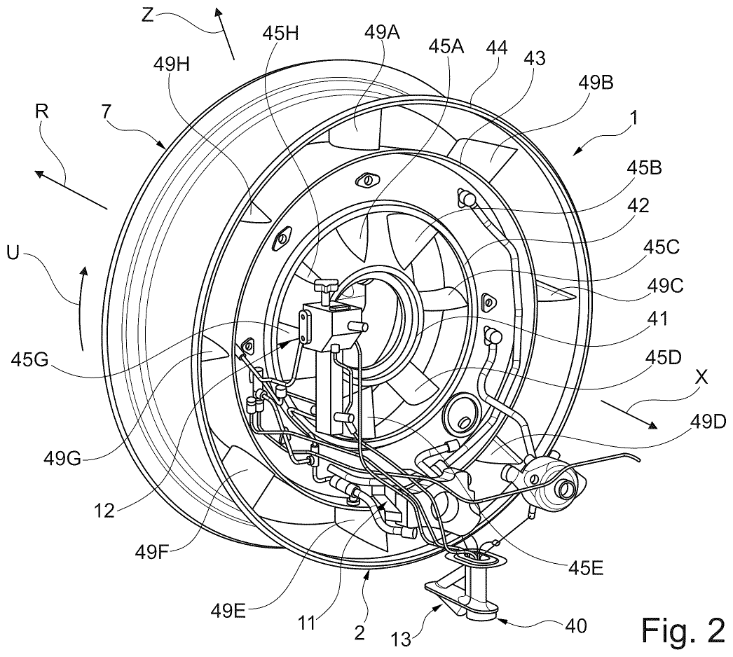

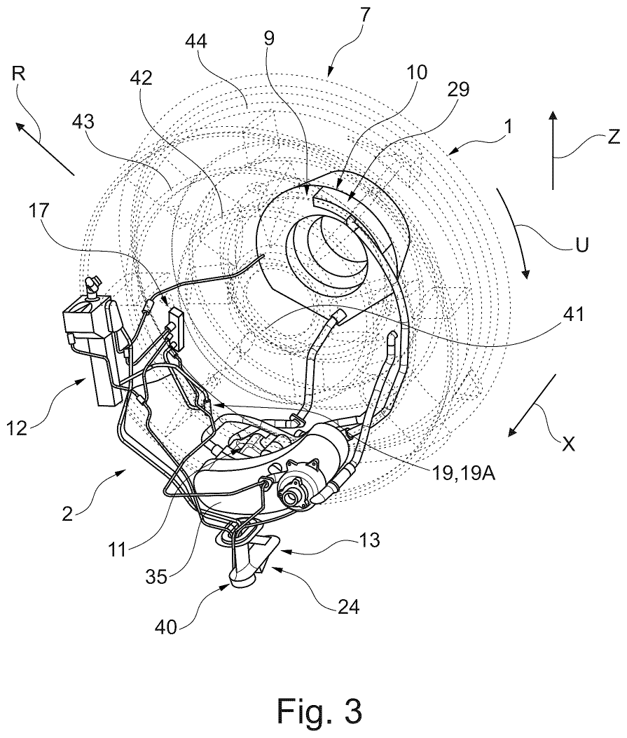

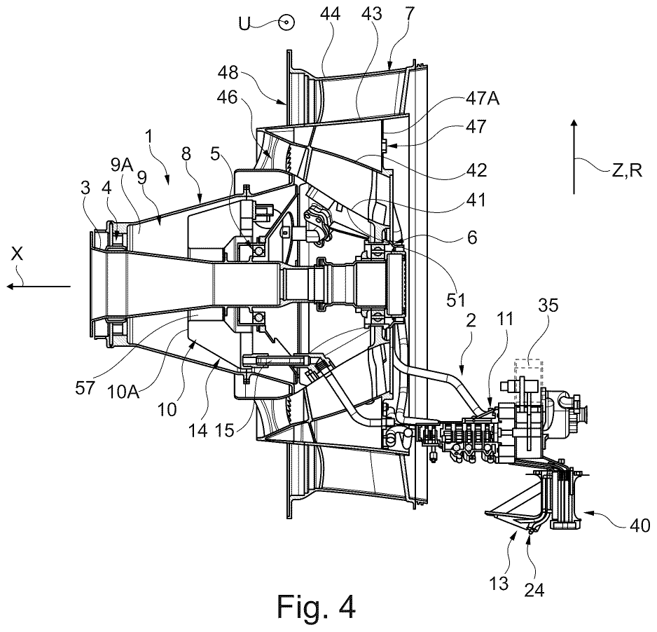

FIG. 1 to FIG. 3 each show different views of a part of a gas turbine engine 1 in a three-dimensional view. The gas turbine engine 1 is an aircraft engine that is equipped with an oil system 2. A shaft 3, shown in more detail in FIG. 4, of the gas turbine engine 1 is mounted rotatably on a casing by means of bearing units 4 to 6. Here, an intermediate casing 7 and a front casing region 8 delimit a bearing chamber 9 in which an oil tank 10 of the oil system 2 is arranged.

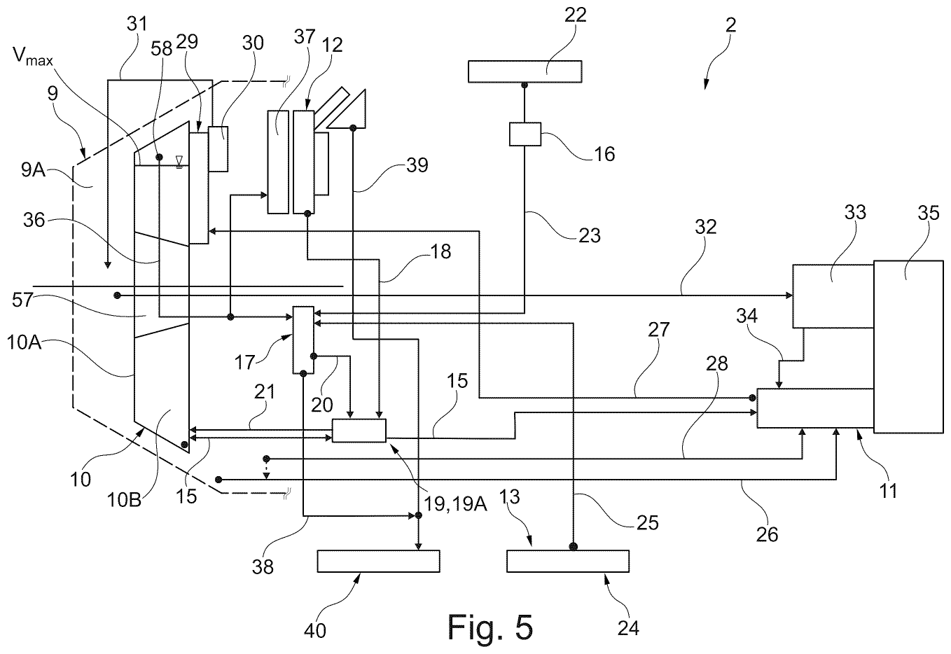

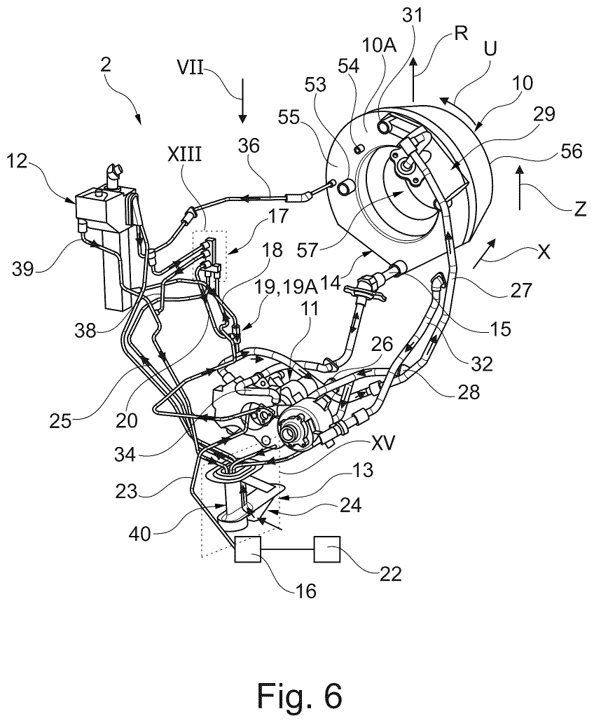

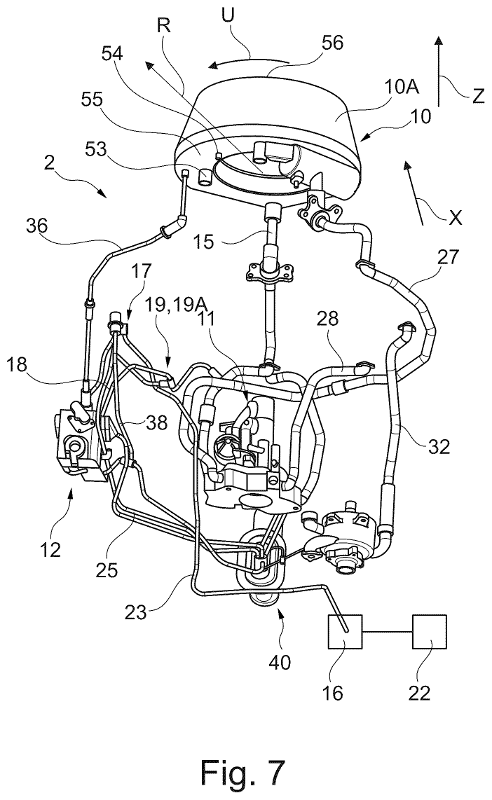

FIG. 5 is a schematic diagram of the oil system 2 showing the connection of the oil tank 10 to a feed pump 11, to a manual filling unit 12 and to a manual pressure filling unit 13. FIG. 6 and FIG. 7 additionally show parts of the oil system 2, in different three-dimensional views in each case.

An oil extraction line 15 branches off from a lower region 14 of a casing 10A of the oil tank 10 as seen in a vertical direction Z in an installed position of the oil tank 10, and said oil extraction line branches to the suction side of the feed pump 11, which during the operation of the gas turbine engine 1 draws oil from the oil tank 10 via the oil extraction line 15. The manual pressure filling unit 13 and a remote filling unit 16 are connectable via a pressure filling valve 17, in a manner described in more detail further below, to the interior of the oil tank 10 in order to be able to introduce oil into the oil tank 10.

The manual filling unit 12 is connected via a filling line 18 and a so-called T-piece 19 to the oil extraction line 15, which during the operation of the oil system 2 constitutes a suction line between the feed pump 11 and the oil tank 10. That portion of the oil extraction line 15 which leads from the T-piece 19 to the oil tank 10 connects the manual filling unit 12 to the interior of the oil tank 10, whereby said portion of the oil extraction line 15 is used for filling the oil tank 10 with oil and, depending on an operating state, constitutes either a suction line portion or a filling line portion. Additionally, the T-piece 19 is also connected to that portion of the oil extraction line 15 which extends between the feed pump 11 and the T-piece 19. Here, the T-piece 19 is arranged in the oil extraction line 15 between the lower region 14 of the casing 10A of the oil tank 10 and the suction side of the feed pump 11. A further filling line 20 extends between the pressure filling valve 17 and a further T-piece 19A. Via the further filling line 20, the oil is conducted from the remote filling unit 16 or from the manual pressure filling unit 13 through the pressure filling valve 17 in the direction of the further T-piece 19A. In the region of the further T-piece 19A, the oil is introduced into the oil extraction line 15 and is subsequently conducted through the filling line portion of the oil extraction line 15 into the interior of the oil tank 10.

Depending on the present usage situation, it is also possible for the oil for filling the oil tank to be introduced into the interior of the oil tank 10 via an additional filling line 21 that extends downstream of the T-pieces 19 and 19A.

When the oil tank 10 is automatically filled with oil from the remote filling unit 16, a feed pump, which is present in the aircraft, of the remote filling unit 16 conveys oil from a further oil tank 22, which is also arranged in the aircraft equipped with the gas turbine engine 1. Here, the oil from the further oil tank 22 is conveyed via a further filling line 23 in the direction of the pressure filling valve 17, and is conducted from there via a further filling line 20 in the direction of the further T-piece 19A and from there in the direction of the oil tank 10.

If the oil tank 10 is filled with oil, with little effort, from the manual pressure filling unit 13 when the aircraft is parked, an operating person introduces oil into an additional filling line 25 of the oil system 2 via a filling interface 24 of the manual pressure filling unit 13 by means of a manually or electrically operable oil pump. The additional filling line 25 conducts the oil in the direction of the pressure filling valve 17. In the region of the pressure filling valve 17, the oil that is supplied under pressure by the manual pressure filling unit 13 is conducted onward in the direction of the further filling line 20, and in the region of the further T-piece 19A is conducted in the direction of the oil tank 10.

It is additionally possible for the oil tank 10 to be filled with oil in substantially unpressurized fashion from the manual filling unit 12. For this purpose, oil is introduced into the manual filling unit 12 from an oil container. The oil flows, owing to the gravitational force acting on it, through the filling line 18 in the direction of the T-piece 19, which is arranged at a lower level in the vertical direction Z and from which the oil enters the oil tank 10 through the oil extraction line 15 under the action of gravitational force.

The oil which is extracted from the oil tank 10 by the feed pump 11 during the operation of the gas turbine engine 1, and which is used inter alia for lubricating and cooling the bearing units 4 to 6, is drawn out of the bearing chamber 9 by the feed pump 11 via a return line 26. Furthermore, the feed pump 11 also draws oil out of other regions of the gas turbine engine 1 via a further return line 28, and conveys the returned oil in the direction of the oil tank 10 via a combined return line 27.

The combined return line 27 opens into an oil separator 29 that is mounted on the casing 10A of the oil tank 10. In the region of the oil separator 29, air that enters the oil separator 29 together with the returned oil is separated from the oil. The oil is introduced from the oil separator 29 into the interior of the oil tank 10, whilst the air that is separated off is discharged via a pressure-limiting valve 30 into the interior of the bearing chamber 9 via a venting line 31. By means of the pressure-limiting valve 30, it is ensured that a pressure in the interior of the oil tank 10 does not fall below a defined pressure level, above which cavitation in the region of the feed pump 10 does not occur.

The bearing chamber 9 is connected via a further venting line 32 and a breather 33, as it is known, in the region of which the amount of oil in the air that is discharged from the bearing chamber 9 is further reduced. The air is subsequently discharged from the breather 33 to the surroundings around the gas turbine engine 1. The breather 33 is connected via an additional return line 34 to the feed pump 11, via which the oil that has been separated off in the region of the breather 33 is introduced by the feed pump 11 back into the oil separator 29 through the combined return line 27.

Both the breather 33 and the feed pump 11 are in this case driven via an auxiliary-unit gear box 35 or an ancillary-equipment gear box. The auxiliary-equipment gear box 35 is specifically designed to drive auxiliary devices and accessories of the gas turbine engine 1. Such auxiliary devices and accessories are for example electrical generators, hydraulic pumps and other systems that are required for the operation of the gas turbine engine 1.

The oil tank 10 is additionally connected via a venting line 36 to the pressure filling valve 17 and to a sensor device 37 of the manual filling unit 12 in order to avoid an inadmissible pressure rise in the oil system 2 during a process of filling the oil tank 10.

Furthermore, the pressure filling valve 17 is connected via a leakage line 38, and the manual filling unit 12 is connected via a further leakage line 39, to a drain mast 40. By means of the drain mast 40, operating persons can visually identify leaks in the region of the pressure filling valve 17 and of the manual filling unit 12, and can easily identify overfilling of the oil tank 10 if oil emerges from the leakage lines 38 and 39 in the region of the drain mast 40, for example.

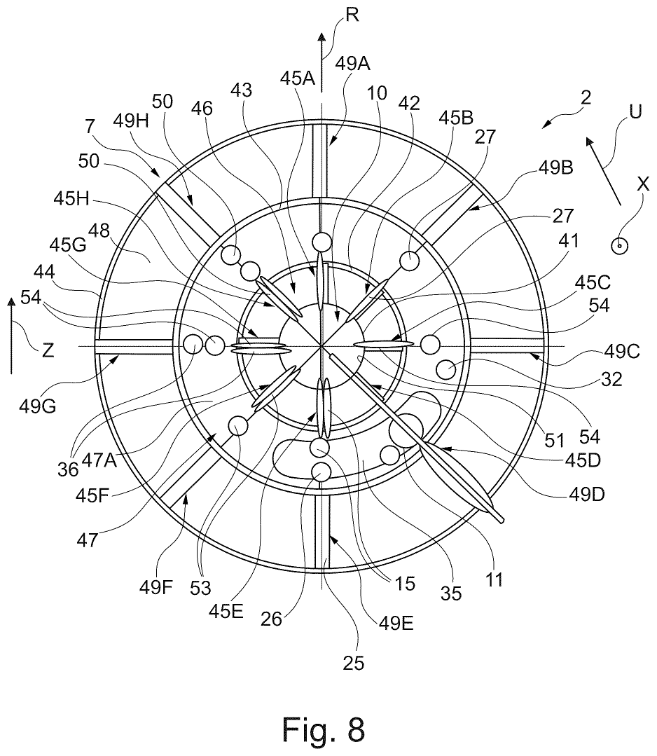

FIG. 8 shows a rear view of the intermediate casing 7, which comprises a plurality of mutually concentrically arranged component regions 41 to 44, which are at least approximately annular in cross section. Here, the component regions 41 and 42, which are interconnected by means of radially extending core struts 45A to 45H, delimit an inlet region 46 of a core air flow of the gas turbine engine 1 both in a radial direction R and in a circumferential direction U. Furthermore, the components 42 and 43 delimit, in the radial direction R and in the circumferential direction U, a so-called torque box 47 which is arranged between the inlet region 46 of the core air flow and an inlet region 48 of a bypass air flow through bypass flow duct (not illustrated in any more detail) of the gas turbine engine 1. The inlet region 48 of the bypass air flow is delimited by the components 43 and 44 in the radial direction R and in the circumferential direction U, said components being fixedly interconnected via so-called bypass flow struts 49A to 49H. The filling line 25 that connects the manual pressure filling unit 13 and the pressure filling valve 17 extends through the bypass flow struts 49E.

The oil tank 10 is arranged in the interior space 9A of the bearing chamber 9 radially within the inlet region 46 of the core air flow. The combined return line 27, proceeding from the feed pump 11, extends from the torque box 47 through the core strut 45B radially inward in the direction of the oil separator 29. Furthermore, a line 54 that conducts sealing air extends from the torque box 47, through the interior of the core struts 45C and 45G, radially inward in the direction of the bearing chamber 9, which is arranged radially within the annular component 41 of the intermediate casing 7.

The oil extraction line 15 extends from the oil tank 10, through the interior of the core strut 45E, outward in the radial direction R into the torque box 47, and subsequently extends in an axial direction X of the gas turbine engine 1 through a rear wall 47A of the torque box 47. Outside the torque box 47, the oil extraction line 15 is connected to the feed pump 11 of the oil system 2. Furthermore, the return line 26 also extends radially outward through the core strut 45E into the torque box 47, subsequently extends through the rear wall 47A, and then extends in the direction of the feed pump 11.

An oil-conducting line 53 extends from the feed pump 11 in the axial direction X through the rear wall 47A into the torque box 47, and from there through the core strut 45F in the direction of the bearing chamber 9. Oil is supplied to the bearing units 5 and 6 from the feed pump 11 via the line 53.

A line 54 which conducts sealing air and via which air is supplied to the bearing units 4 to 6 extends inward in the radial direction R through the core strut 45G between the torque box 47 and the bearing chamber 9. Additionally, the venting line 36 of the oil tank 10 extends outward in the radial direction R through the core strut 45G, through the inlet region 46 of the core air flow, into the interior of the torque box 47, and subsequently extends in the axial direction X through the rear wall 47A, and onward from there in the direction of the pressure filling valve 17. A further oil-conducting line 50 extends through the rear wall 47A and the interior of the core strut 45H from the feed pump 11 in the direction of the bearing unit 4, in order to be able to supply the desired amount of oil thereto.

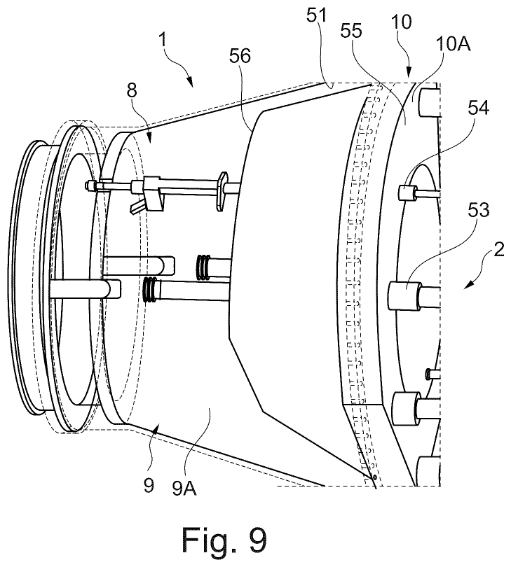

Since the oil tank 10, at the circumference or in the radial direction R, lies against or adjoins an inner side 51 of the radially inner annular component 41 substantially without a gap, the lines 53 and 54 extend in the axial direction X through the casing 10A in the manner illustrated in more detail in FIG. 9. Here, the lines 53 and 54 extend in the axial direction X through a first side wall 55 of the casing 10A, through the interior space 10B of the oil tank 10 and subsequently through a second side wall 56 of the casing 10A.

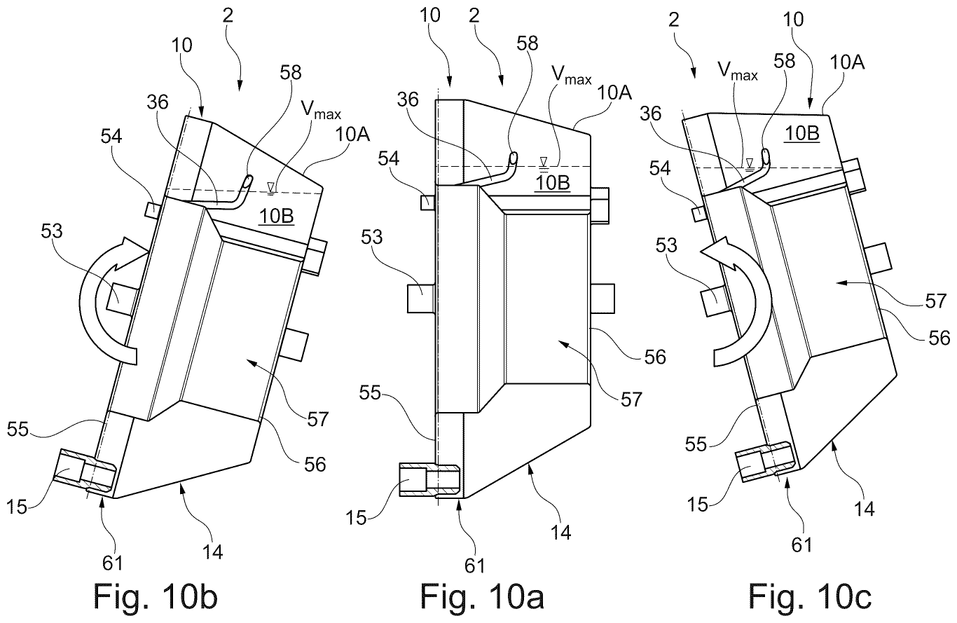

FIG. 10a is a longitudinal sectional view of the casing 10A of the oil tank 10 during horizontal flight. It can be seen from the illustration in FIG. 10a that the casing 10A delimits, in the radial direction R, a central circular aperture 57, through which the shaft 3 extends in the axial direction X in the manner illustrated in more detail in FIG. 4. An opening 58 of the venting line 36 of the oil tank 10 is arranged in that region of the interior space 10B of the oil tank 10 which is arranged above the circular aperture 57 in the radial direction R. The opening 58 of the venting line 36 is situated in the interior space 10B of the oil tank 10 in a defined manner above the maximum level Vmax.

FIG. 10b is an illustration, corresponding to FIG. 10a, of the oil tank 10 when an aircraft equipped with the gas turbine engine 1 is in climbing flight, in which the aircraft has a pitch angle of approximately +40° about a transverse axis relative to the horizontal flight attitude. Owing to the defined positioning of the opening 58 in the oil tank 10, the opening 58 remains slightly above the maximum oil level Vmax in the oil tank during said climbing flight.

By contrast, FIG. 10c is an illustration, corresponding to FIG. 10a, of the oil tank 10 during descending flight, in which the aircraft has a pitch angle of −40° about its transverse axis. It is also the case during descending flight that the opening 58 of the venting line 36 is situated above the maximum oil level Vmax in the oil tank 10.

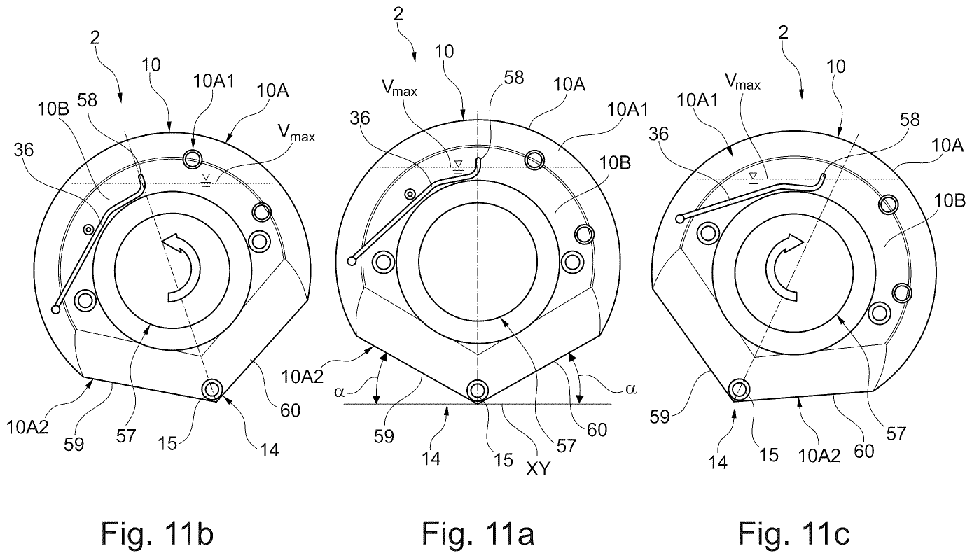

Furthermore, the opening 58 of the venting line 36 is arranged in the oil tank 10 such that the opening 58 is permanently arranged above the maximum residue Vmax in the oil tank 10 when the gas turbine engine 1 is in flight attitudes at which the aircraft assumes a roll angle of +/−40° about a longitudinal axis in relation to a horizontal flight attitude illustrated in FIG. 11a. The pivoting positions of the oil tank that deviate from the horizontal flight attitude are shown in FIGS. 11b and 11c.

It is thus ensured throughout the operation of the aircraft that no oil escapes from the oil tank 10 via the venting line, as long as said oil tank is not in an over-filled state.

To minimize the oil volume that cannot be extracted from the oil tank 10 via the extraction line 15 for structural reasons, the upper region 10A1 of the casing 10A of the oil tank 10 when the oil tank 10 is in an installed position is annular. A lower region 10A2, which adjoins said upper region in the vertical direction Z and in the circumferential direction U, of the casing 10A has flattened casing sides 59, 60 which converge on one another in the circumferential direction U of the casing 10A of the oil tank 10 and which delimit the volume of the oil tank 10. The casing sides 59 and 60 each enclose an angle α of greater than 30° and preferably less than 45° with a horizontal plane XY. Additionally, the lower region of the casing 10A of the oil tank 10 tapers continuously in the axial direction X proceeding from the upper region of the casing 10A in the direction of a lower end 61 of the casing 10A, such that that oil volume situated in the oil tank 10 which cannot be discharged from the interior of the oil tank 10 through the oil extraction line 15 is minimal.

Depending on the usage situation, the storage volume of the oil tank 10 is more than 15 liters, preferably more than 20 liters, and depending on the usage situation may even be more than 40 liters. Altogether, the volume of the oil tank 10 has an expansion volume of approximately 20%.

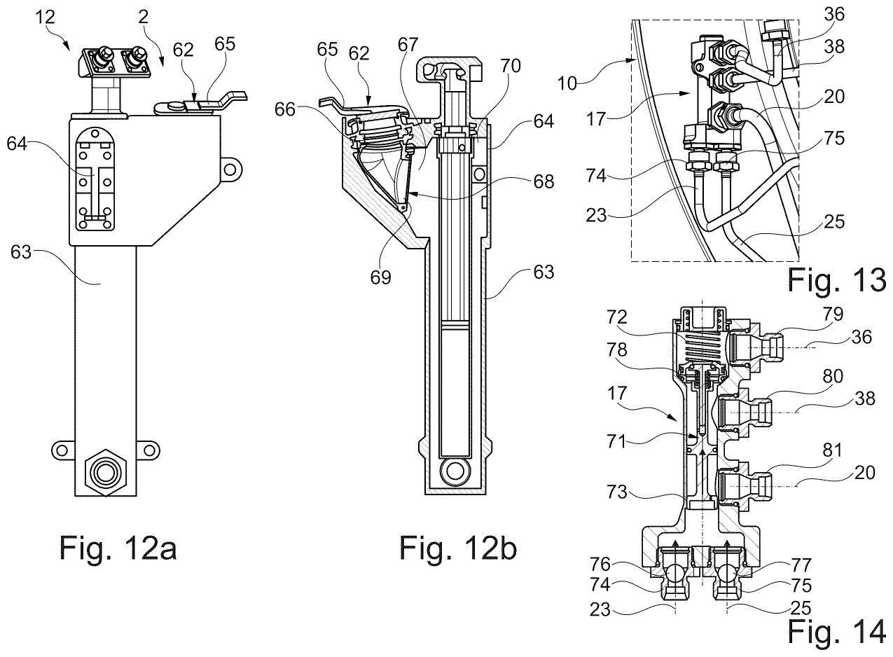

FIG. 12a shows a side view of the manual filling unit 12 in isolation, whilst FIG. 12b is a sectional view of the manual filling unit 12. A manual oil filler neck 62 of the manual filling unit 12 is installed in a casing 63 of the manual filling unit 12 in a position which allows manual filling of the oil tank 10 and, at the same time, an inspection of the oil level in the oil tank 10 by means of an oil inspection glass 64. For this purpose, the oil inspection glass 64 is installed in the immediate vicinity of the oil filler neck 62. The position of the oil filler neck 62 is configured, in relation to the oil level in the oil tank 10, for a typical ground attitude of an aircraft equipped with the gas turbine engine 1. The likelihood of manual overfilling of the oil tank 10 by an operating person is thus minimized.

To be able to visually indicate to an operating person that a cover 65 of the oil filler neck 62 has not been completely closed, the bottom side of the cover 65 may for example be colored with a signal color, preferably a red color. Furthermore, in the region between a filling opening 66 and an interior space 67 of the casing 63, a flap valve 68 may be provided, by means of which it is ensured that no oil is lost if the cover 65 of the oil filler neck 62 is not closed. Here, a baffle plate 69 of the flap valve 68 may be installed such that the casing 62 and the baffle plate 69 do not interfere with one another.

Furthermore, the baffle plate 69 may be positioned such that the baffle plate 69, in the closed position, encloses an angle of approximately 10° with the vertical direction Z. It is thus achieved that the baffle plate 69 lies, under its own weight, sealingly against a seal. To allow an unimpeded introduction of oil into the interior space 67 of the casing 63, the baffle plate 69 may be pivotable through an angle of preferably 130° relative to its closed position.

A cavity 70 that is arranged behind the oil inspection glass 64 is vented via a venting line in the direction of the drain mast 40, which means that an accumulation of air that influences the oil level display cannot occur in the cavity.

The sensor device 37 of the manual filling unit 12 may for example be designed as a capacitive sensor consisting of three isolated concentric tubes that generate two different capacitances. One of the generated capacitances, which in such an embodiment of the filling unit 12 is commonly referred to as capacitor capacitance, can be processed by an external device in order to compensate for the changes in the oil dielectric that are caused by environmental conditions and the aging of the oil. A second capacitance that is referred to as sensor capacitance can, on the basis of a known dielectric oil value that is processed by the capacitor capacitance, deliver a capacitance signal that is directly dependent on the oil level. The general measurement principle that forms the basis for this measuring method is then based on a change in the dielectric value between the air and the oil in the region between the immersed tube lengths.

The casing 63 of the manual filling unit 12 may, depending on the present usage situation, be installed in the region of the engine core of the gas turbine engine 1 or in the region of an outer side of the intermediate casing 7.

The arrangement of the oil tank 10 in the bearing chamber 9 means that the oil tank 10 or its casing 10A does not necessarily need to be of fire-resistant design, because the bearing chamber 9 does not constitute a safety-critical fire zone of the gas turbine engine 1. Owing to the arrangement in the bearing chamber 9, the oil tank 10 is additionally protected, by the annular components 41 to 44 of the intermediate casing 7 that surround the bearing chamber 9, against components or projectiles penetrating at high speed into the interior of the gas turbine engine 1. The likelihood of a loss of oil is thus reduced in relation to known solutions, in which the oil tank is arranged in the region of the ancillary-equipment gear box 35 and thus outside the bearing chamber.

FIG. 13 is an enlarged view of a region XIII, indicated more specifically in FIG. 6, in which the pressure filling valve 17 is arranged. Furthermore, FIG. 14 is a sectional view of the pressure filling valve 17. The pressure filling valve 17 has a valve piston 71 which, in the unpressurized state, is forced sealingly against a first valve seat 73 by a spring element 72 and shuts off connections between the remote filling unit 16 and the oil tank 10 and between the manual pressure filling unit 13 and the oil tank 10. When an opening pressure is applied from the remote filling unit 16 or from the manual pressure filling unit 13, the valve piston 71 opens up the respective connections.

In the region of a first connection 74 of the pressure filling valve 17, said first connection being connected to the remote filling unit 16 via the further filling line 23, and in the region of a second connection 75, which is connected to the manual pressure filling unit 13 via the additional filling line 25, there is in each case one check valve 76 and 77 respectively. The check valves 76 and 77 open up the respectively associated connection 74 or 75 when the pressure in the pressure filling valve 17 is lower than that in the respective filling line 23 or 25.

Furthermore, the valve piston 71, in the unpressurized state, also lies sealingly against a second valve seat 78 and separates a third connection 79 from a fourth connection 80. Here, the third connection 79 is connected to the venting line 36 of the oil tank 10, whilst the leakage line 38 branches off from the fourth connection 80 of the pressure filling valve 17 and produces a connection to the drain mast 40 which is mounted in a region, close to an outer side 88 of an engine nacelle 86, within the gas turbine engine 1.

A fifth connection 81 of the pressure filling valve 17 is operatively connected via the further filling line 20 and the further T-piece 19A to the oil extraction line 15. Here, when the first valve seat 73 is open, the fifth connection 81 is connected to the connections 74 and 75 in order to be able to conduct oil from the remote filling unit 16 or from the manual pressure filling unit 13 through the pressure filling valve 17 in the direction of the oil tank 10. It is thus possible for the oil tank 10 to be filled with oil remotely or manually and in pressure-driven fashion via the pressure filling valve 17. Additionally, the valve piston 71 permanently shuts off the third connection 79 and the fourth connection 80 from the first connection 74, from the second connection 75 and from the fifth connection 81.

The pressure filling valve 17 is installed in the gas turbine engine 1 separately from the casing 63 of the manual filling unit 12, and is positioned as low as possible in the engine core in the vertical direction Z in order to facilitate the emptying of the oil tank 10 in the event of overfilling. To prevent the ingress of dirt particles into the oil system 2, a separate screen may be provided in the region of the pressure filling valve 17.

If oil remains in the venting line 36 of the oil tank 10 after the end of the remote filling operation of the oil tank 10, the oil is, during the next use of the pressure filling valve 17, discharged via the fourth connection 80 and the leakage line 38 in the direction of the drain mast 40.

When the oil tank 10 is being filled, the rising oil level in the oil tank 10 in the region of the manual filling unit 12 is both visually displayed, in a continuously updated manner, in the region of the oil inspection glass 64 and capacitively determined by the sensor device 37. The position of the opening 58 of the venting line 36 in the oil tank 10 is such that the filling of the oil tank by the remote filling unit 16 is deactivated, on the basis of the sensor signal from the sensor device 37, in good time before overfilling of the oil tank 10 occurs.

When the valve piston 71 opens up the second valve seat, the third connection 79 is connected to the fourth connection 80. Overfilling of the oil tank 10 is then prevented in a simple manner by virtue of all of the excess oil in the oil tank 10 flowing out through the pressure filling valve 17 and the fourth connection 80 in the direction of the drain mast 40 and being discharged from the oil system 2. An overpressure and resulting damage in the region of the feed pump 11, of the pressure-limiting valve 30 and of the oil tank 10 are thus prevented.

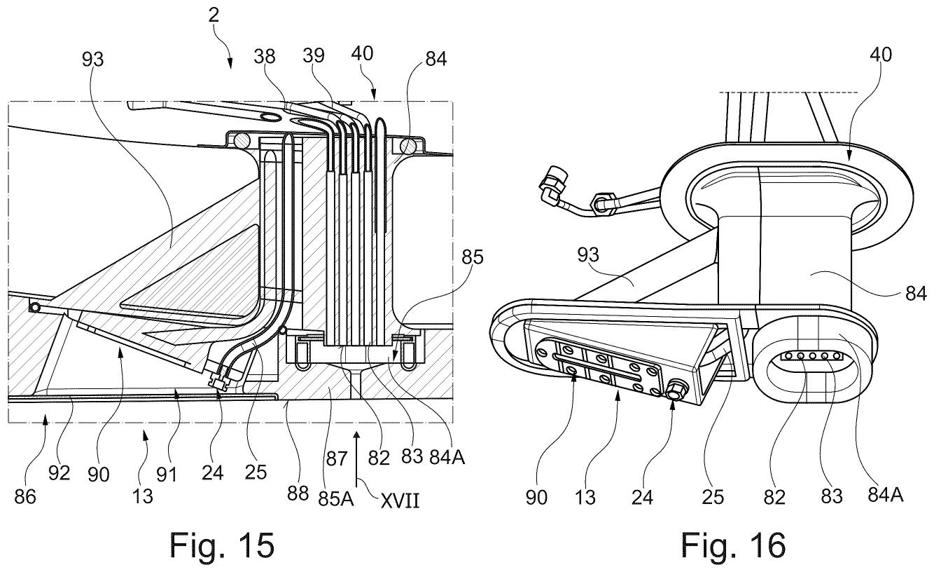

FIG. 15 shows an enlarged view of a region XV indicated more specifically in FIG. 4. The drain mast 40 and the manual pressure filling unit 13 are arranged in the region XV. The leakage lines 38 and 39, among others, open out in the drain mast, the openings 82, 83 of said leakage lines being arranged in the region of a bottom side of a casing 84 of the drain mast 40 and being illustrated in FIG. 16. The openings 82, 83 are surrounded by a sealing element 84A, which in the present case is of oval form and which is sealingly connected to an inner side 85 of a wall 85A of the engine nacelle 86. A hole 87 extends through the wall 85A of the engine nacelle 86 and opens into an outer side 88 of the wall 85A of the engine nacelle 86. Overfilling of the oil tank 10, or the escape of leakage oil from other regions, can thus be identified with little effort by way of a simple visual inspection.

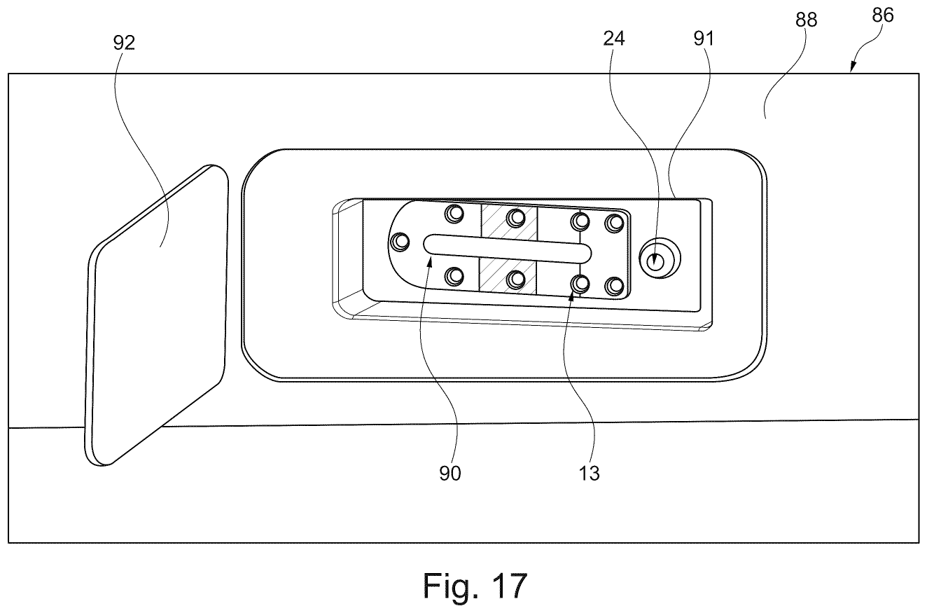

Arranged adjacent to the drain mast 40 is the manual pressure filling unit 13, in the region of which the filling line 25 is connected to the manual pressure filling interface 24. Adjacent to the pressure filling interface 24, the manual pressure filling unit 13 comprises an oil level display 90 illustrated in FIG. 17, preferably a type of oil inspection glass, which displays the present oil level in the oil tank 10 via a corresponding glass fiber optical system.

For ease of handling, the manual pressure filling unit 13 is positioned in a lower region of the gas turbine engine 1 in the region of the outer side 88 of the engine nacelle 86. The manual pressure filling unit 13 is thus easily operable from the outside through an opening 91 in the outer side 88 of the engine nacelle 86. The opening 91 is closable by means of a covering flap 92, which is pivotable relative to the outer side 88 of the engine nacelle 86 from the closed position shown in FIG. 15 into the open position shown in FIG. 16. Here, an outer side of the covering flap 92 terminates flush with the outer side 88 of the engine nacelle 86 in an operating state in which said covering flap closes the opening 91.

### LIST OF REFERENCE SIGNS

1 Gas turbine engine
2 Oil system
3 Shaft
4 to 6 Bearing unit
7 Intermediate casing
8 Front casing region
9 Bearing chamber
9A Interior space of the bearing chamber
10 Oil tank
10A Casing of the oil tank
10A1 Upper region of the casing of the oil tank
10A2 Lower region of the casing of the oil tank
10B Interior space of the casing of the oil tank
11 Feed pump
12 Manual filling unit
13 Manual pressure filling unit
14 Lower region of the oil tank
15 Oil extraction line
16 Remote filling unit
17 Pressure filling valve
18 Filling line between the manual filling unit and the T-piece
19 T-piece
19A Further T-piece
20 Further filling line between the pressure filling valve and the further T-piece
21 Additional filling line between the T-piece 19 or the further T-piece 19A and the oil tank 10
22 Further oil tank
23 Further filling line between the further oil tank and the pressure filling valve
24 Filling interface of the manual pressure filling unit 13
25 Additional filling line between the manual pressure filling unit 13 and the pressure filling valve 17
26 Return line
27 Combined return line
28 Further return line
29 Oil separator
30 Pressure-limiting valve
31 Venting line between the pressure-limiting valve and the bearing chamber
32 Further venting line between the bearing chamber and the breather 33
33 Breather
34 Additional return line between the breather and the feed pump
35 Ancillary-equipment gear box
36 Venting line of the oil tank
37 Sensor device of the manual filling unit
38 Leakage line of the pressure filling valve
39 Leakage line of the manual filling unit 12
40 Drain mast
41 to 44 Annular component of the intermediate casing 7
45A to 45H Core struts
46 Inlet region of the core air flow
47 Torque box of the intermediate casing 7
47A Rear wall of the torque box
48 Inlet region of the bypass air flow
49A to 49H Bypass flow struts
50 Oil line
51 Inner side of the annular component 41
53, 54 Line through the oil tank
55 First side wall of the casing of the oil tank
56 Second side wall of the casing of the oil tank
57 Circular aperture in the casing of the oil tank
58 Opening of the venting line 36
59 Casing side
60 Casing side
61 Lower end of the casing 10A
62 Oil filler neck
63 Casing of the manual filling unit
64 Oil inspection glass of the manual filling unit
65 Cover of the oil filler neck
66 Filling opening
67 Interior space of the casing 63
68 Flap valve
69 Baffle plate
70 Cavity
71 Valve piston
72 Spring element
73 First valve seat
74 First connection of the pressure filling valve
75 Second connection of the pressure filling valve
76 Check valve
77 Check valve
78 Second valve seat
79 Third connection of the pressure filling valve
80 Fourth connection of the pressure filling valve
81 Fifth connection of the pressure filling valve
82 Opening
83 Opening
84 Casing of the drain mast
84A Sealing element
85 Inner side of the wall of the engine nacelle
85A Wall of the engine nacelle
86 Engine nacelle
87 Hole in the wall of the engine nacelle
88 Outer side of the engine nacelle
90 Oil level display of the manual pressure filling unit
91 Opening in the engine nacelle
92 Covering flap
93 Mounting strut of the drain mast
R Radial direction
U Circumferential direction
Vmax Maximum oil level in the oil tank
X Axial direction
XY Horizontal plane
Z Vertical direction
α Angle

1. A gas turbine engine for an aircraft, having an oil system that comprises an oil tank, and having at least one shaft that is mounted rotatably on a casing by means of bearing units, at least one of the bearing units and the oil tank being arranged in a bearing chamber,
wherein
an interior space of a casing of the oil tank is connected via a venting line to a breather, in the region of which the amount of oil in the air can be reduced.

2. The gas turbine engine as claimed in claim 1,
wherein
an interior space of the bearing chamber is connected via a venting line to the breather.

3. The gas turbine engine as claimed in claim 1,
wherein,
in the venting line of the oil tank, there is a pressure-limiting valve which, below a defined pressure in the casing of the oil tank, blocks the venting line of the oil tank in the direction of the bearing chamber or of the breather.

4. The gas turbine engine as claimed in claim 1,
wherein
an oil separator is arranged on the casing of the oil tank, in the region of which oil separator oil can be separated off from an air-oil volume flow during the operation of the gas turbine engine, it being possible for oil that has been separated off to be conducted via an oil line from the oil separator into the oil tank and for the pre-purified air to be conducted via an air line from the oil separator in the direction of the breather or of the interior space, in the region of which the amount of oil in the pre-purified air can be further reduced, of the bearing chamber.

5. The gas turbine engine as claimed in claim 1,
wherein
an upper region of the casing when the oil tank is in an installed position is annular, and an adjoining lower region has flattened casing sides which converge on one another in the circumferential direction of the casing of the oil tank and which delimit the volume of the oil tank.

6. The gas turbine engine as claimed in claim 5,
wherein
the lower region of the casing of the oil tank tapers continuously in the axial direction proceeding from the upper region of the casing in the direction of a lower end of the casing.

7. The gas turbine engine as claimed in claim 1,
wherein
the casing of the oil tank delimits, in the radial direction, a preferably circular aperture through which the shaft extends in the axial direction.

8. The gas turbine engine as claimed in claim 1,
wherein
the casing of the oil tank has a plurality of lines which extend in the axial direction from a first side wall of the casing through the interior space to a second side wall of the casing.

9. The gas turbine engine as claimed in claim 8,
wherein
oil can be conducted through the oil tank in the direction of one of the bearing units through at least one of the lines, and sealing air for sealing off the bearing chamber can be conducted through at least one other of the lines.

10. The gas turbine engine as claimed in claim 1,
wherein
the oil tank is operatively connectable via a pressure filling valve to a remote filling unit, via which oil can be conducted in automated fashion into the oil tank from a further aircraft oil tank, and to a manual pressure filling unit, from which oil can be introduced into the oil tank manually and under pressure.

11. The gas turbine engine as claimed in claim 10,
wherein
a filling line which connects the manual pressure filling unit and the pressure filling valve extends through a bypass flow strut which extends in a radial direction between, and fixedly interconnects, two annular casing regions.

12. The gas turbine engine as claimed in claim 10,
wherein
the pressure filling valve has a valve piston which, in an unpressurized state, is forced sealingly against a first valve seat by a spring element and shuts off the connections between the remote filling unit and the oil tank and between the manual pressure filling unit and the oil tank and which, when an opening pressure is applied from the remote filling unit or from the manual pressure filling unit, opens up the respective connections.

13. The gas turbine engine as claimed in claim 10,
wherein,
in the region of a first connection of the pressure filling valve, said first connection being connected to the remote filling unit, and in the region of a second connection, which is connected to the manual pressure filling unit, there is in each case one check valve which opens up the associated connection when the pressure in the pressure filling valve is lower than that in the respective filling line between the remote filling unit and the pressure filling valve and between the manual pressure filling unit and the pressure filling valve and the valve piston, in the unpressurized state, lies sealingly against a second valve seat and separates a third connection from a fourth connection of the pressure filling valve, the third connection being connected to the venting line of the oil tank, and a leakage line branching off from the fourth connection of the pressure filling valve and producing a connection to a drain mast which is mounted in the interior of an engine nacelle and adjacent to an outer side of the engine nacelle.

14. The gas turbine engine as claimed in claim 13,
wherein,
when the oil tank is in an installed position and an aircraft equipped with the gas turbine engine is in flight attitudes at which the aircraft assumes a roll angle of +/−40° about a longitudinal axis and a pitch angle of +/−40° about a transverse axis relative to a horizontal flight attitude, an opening of the venting line in the interior space of the oil tank is arranged with a defined offset above a defined maximum oil level (Vmax) in the oil tank.

15. The gas turbine engine as claimed in claim 10,
wherein
the pressure filling valve is connected via the venting line a manual filling unit.
